(19) United States
(12) Patent Application Publication
(10) Pub. No.: US 2025/0077769 A1
(43) Pub. Date: Mar. 6, 2025

(54) TECHNOLOGIES FOR LEVERAGING IMPROVED CONVERSATIONAL BOTS IN A CONTACT CENTER SYSTEM

(71) Applicant: Genesys Cloud Services, Inc., Menlo Park, CA (US)

(72) Inventors: Ramasubramanian Sundaram, Gachibowli (IN); Naresh Kumar Elluru, Gachibowli (IN); Pavan Kumar Buduguppa, Gachibowli (IN)

(21) Appl. No.: 18/459,352

(22) Filed: Aug. 31, 2023

(51) Int. Cl. G06F 40/216; G06F 40/284; G06F 40/35

(52) U.S. Cl. CPC G06F 40/216; G06F 40/284; G06F 40/35

(57) ABSTRACT

A method of leveraging improved conversational bots in a contact center system according to an embodiment includes performing knowledge distillation through machine learning to teach a student artificial intelligence model based on a teacher artificial intelligence model and reduce a size of an initial multilingual vocabulary, wherein the student artificial intelligence model includes fewer machine learning embedding layers than the teacher artificial intelligence model, removing tokens from the initial multilingual vocabulary based on a grouping of languages with linguistic similarities to reduce the size of the initial multilingual vocabulary, parsing user text from a human user into one or more tokens, identifying token indexes associated with the respective one or more tokens in a reduced multilingual vocabulary, determining embedding values associated with the identified token indexes, and generating a multilingual embedding output for the user text indicative of user intent based on the embedding values using machine learning.

### BACKGROUND

Conversational bots have become ubiquitous tools for businesses and contact centers to deliver improved customer experiences and responsiveness to their clients. Given the rise of deep learning techniques, improved hardware, and artificial intelligence platforms, the development of conversational bots has proliferated. Some key factors in developing effective conversational bots include the feature representation of the input text (e.g., user query) and the response time of the conversational bot. Conversational bot systems generally utilize large vocabulary lists to represent input features, enabling the bot to accurately understand the user's intent and generate appropriate responses.

### SUMMARY

One embodiment is directed to a unique system, components, and methods for leveraging improved conversational bots in a contact center system. Other embodiments are directed to apparatuses, systems, devices, hardware, methods, and combinations thereof for leveraging improved conversational bots in a contact center system.

According to an embodiment, a method of leveraging improved conversational bots in a contact center system may include performing, by a computing system, knowledge distillation through machine learning to teach a student artificial intelligence model based on a teacher artificial intelligence model and reduce a size of an initial multilingual vocabulary, wherein the student artificial intelligence model includes fewer machine learning embedding layers than the teacher artificial intelligence model, removing, by the computing system, tokens from the initial multilingual vocabulary based on a grouping of languages with linguistic similarities to reduce the size of the initial multilingual vocabulary, parsing, by the computing system, user text from a human user into one or more tokens using natural language processing, identifying, by the computing system, token indexes associated with the respective one or more tokens in a reduced multilingual vocabulary, wherein the reduced multilingual vocabulary is generated from performing the knowledge distillation and removing the tokens from the initial multilingual vocabulary, determining, by the computing system, embedding values associated with the identified token indexes, and generating, by the computing system, a multilingual embedding output for the user text based on the embedding values using machine learning, wherein the multilingual embedding output is indicative of an intent of the user text.

In some embodiments, performing knowledge distillation through machine learning to teach the student artificial intelligence model based on the teacher artificial intelligence model and reduce the size of the initial multilingual vocabulary may include reducing a memory consumption of the initial multilingual vocabulary.

In some embodiments, removing the tokens from the initial multilingual vocabulary based on the grouping of languages with linguistic similarities to reduce the size of the initial multilingual vocabulary may include reducing a memory consumption of the initial multilingual vocabulary.

In some embodiments, performing the knowledge distillation through machine learning to teach the student artificial intelligence model based on the teacher artificial intelligence model may include performing machine learning to train the student artificial intelligence model with respect to the teacher artificial intelligence model's representation of contact center keywords.

In some embodiments, performing the knowledge distillation through machine learning to teach the student artificial intelligence model based on the teacher artificial intelligence model may include performing machine learning to train the student artificial intelligence model with respect to the teacher artificial intelligence model's representation of domain-specific keywords.

In some embodiments, removing tokens from the initial multilingual vocabulary based on the grouping of languages with linguistic similarities may include determining one or more languages relevant to a locale handled by the contact center system, and removing tokens from the initial multilingual vocabulary associated with languages not within a group of languages relevant to the locale handled by the contact center system.

In some embodiments, generating the multilingual embedding output for the user text based on the embedding values may include generating a fixed length vector representation of the user text based on the embedding values.

In some embodiments, generating the multilingual embedding output for the user text based on the embedding values using machine learning may include generating the multilingual embedding output for the user text based on the embedding values using a neural network.

In some embodiment, the method may further include receiving, by the computing system, the user text from an interaction between the human user and a conversational bot of the contact center system.

In some embodiments, each token of the initial multilingual vocabulary may be represented by a multi-dimensional vector of floating point values.

According to another embodiment, a computing system for leveraging improved conversational bots in a contact center system may include at least one processor and at least one memory comprising a plurality of instructions stored thereon that, in response to execution by the at least one processor, causes the computing system to perform knowledge distillation through machine learning to teach a student artificial intelligence model based on a teacher artificial intelligence model and reduce a size of an initial multilingual vocabulary, wherein the student artificial intelligence model includes fewer machine learning embedding layers than the teacher artificial intelligence model, remove tokens from the initial multilingual vocabulary based on a grouping of languages with linguistic similarities to reduce the size of the initial multilingual vocabulary, parse user text from a human user into one or more tokens using natural language processing, identify token indexes associated with the respective one or more tokens in a reduced multilingual vocabulary, wherein the reduced multilingual vocabulary is generated from performing the knowledge distillation and removing the tokens from the initial multilingual vocabulary, determine embedding values associated with the identified token indexes, and generate a multilingual embedding output for the user text based on the embedding values using machine learning, wherein the multilingual embedding output is indicative of an intent of the user text.

In some embodiments, to perform knowledge distillation through machine learning to teach the student artificial intelligence model based on the teacher artificial intelligence model and reduce the size of the initial multilingual vocabulary may include to reduce a memory consumption of the initial multilingual vocabulary.

In some embodiments, to remove the tokens from the initial multilingual vocabulary based on the grouping of languages with linguistic similarities to reduce the size of the initial multilingual vocabulary may include to reduce a memory consumption of the initial multilingual vocabulary.

In some embodiments, to perform the knowledge distillation through machine learning to teach the student artificial intelligence model based on the teacher artificial intelligence model may include to perform machine learning to train the student artificial intelligence model with respect to the teacher artificial intelligence model's representation of contact center keywords.

In some embodiments, to perform the knowledge distillation through machine learning to teach the student artificial intelligence model based on the teacher artificial intelligence model may include to perform machine learning to train the student artificial intelligence model with respect to the teacher artificial intelligence model's representation of domain-specific keywords.

In some embodiments, to remove tokens from the initial multilingual vocabulary based on the grouping of languages with linguistic similarities may include to determine one or more languages relevant to a locale handled by the contact center system, and remove tokens from the initial multilingual vocabulary associated with languages not within a group of languages relevant to the locale handled by the contact center system.

In some embodiments, to generate the multilingual embedding output for the user text based on the embedding values may include to generate a fixed length vector representation of the user text based on the embedding values.

In some embodiments, to generate the multilingual embedding output for the user text based on the embedding values using machine learning may include to generate the multilingual embedding output for the user text based on the embedding values using a neural network.

In some embodiments, the plurality of instructions may further cause the computing system to receive the user text from an interaction between the human user and a conversational bot of the contact center system.

In some embodiments, each token of the initial multilingual vocabulary may be represented by a multi-dimensional vector of floating point values.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a system for leveraging improved conversational bots in a contact center system;

FIG. 2 is a simplified block diagram of at least one embodiment of a cloud-based system;

FIG. 3 is a simplified block diagram of at least one embodiment of a computing device;

FIG. 4 is a simplified flow diagram of at least one embodiment of a method of reducing the size of and augmenting a multilingual vocabulary;

FIG. 5 is a simplified flow diagram of at least one embodiment of a method of leveraging improved conversational bots in a contact center system;

FIG. 6 is a simplified diagram of at least one embodiment of an architecture of a multilingual encoder model; and

FIG. 7 is a simplified flow diagram of at least one embodiment of an architecture for training a student artificial intelligence model.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

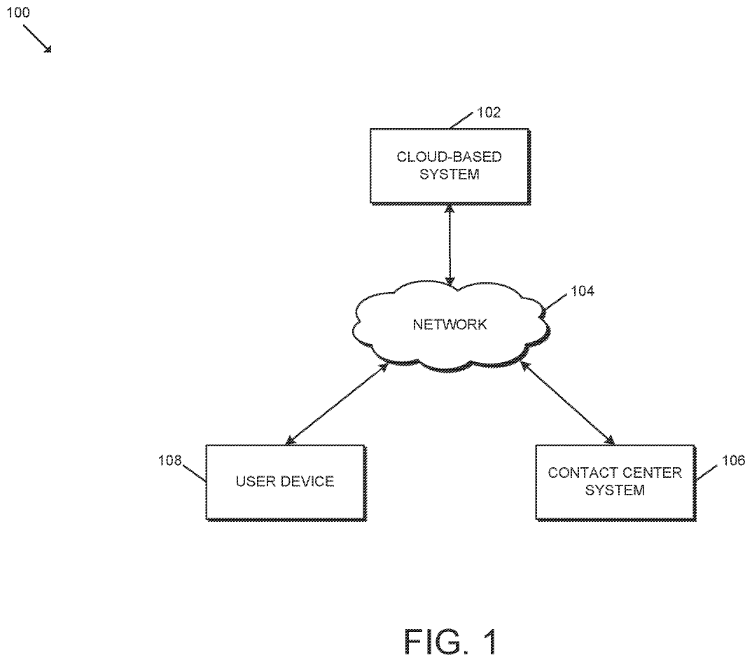

Referring now to FIG. 1, in the illustrative embodiment, a system 100 for leveraging improved conversational bots in a contact center system includes a cloud-based system 102, a network 104, a contact center system 106, and a user device 108. Although only one cloud-based system 102, one network 104, one contact center system 106, and one user device 108 are shown in the illustrative embodiment of FIG. 1, the system 100 may include multiple cloud-based systems 102, networks 104, contact center systems 106, and/or user devices 108 in other embodiments. For example, in some embodiments, multiple cloud-based systems 102 (e.g., related or unrelated systems) may be used to perform the various functions described herein. Further, in some embodiments, one or more of the systems described herein may be excluded from the system 100, one or more of the systems described as being independent may form a portion of another system, and/or one or more of the systems described as forming a portion of another system may be independent.

It should be appreciated that the system 100 may reduce the size of a multilingual vocabulary and artificial intelligence model (e.g., through knowledge distillation), and/or otherwise leverage the technologies described herein for improved conversational bot performance in contact centers. Contact center systems 106 often provide services to an enterprise within a particular locale (e.g., Eastern Europe, East Asia, etc.), and therefore conversational bots supporting the locale must be able to understand languages spoken by human users within the locale. One approach to ensuring that all relevant languages are supported may include leveraging, for example, a large open source multilingual vocabulary that includes many different languages (e.g., 80+ languages) and corresponding words/tokens. However, the downside to using such a large multilingual vocabulary is that it consumes a large amount of memory to store the vocabulary and/or embeddings, and execution speed may be slower than when compared to using a smaller, targeted vocabulary.

In the illustrative embodiment, rather than using such a large multilingual vocabulary, the system 100 may group languages that exhibit linguistic similarities (e.g., group Eastern European languages together, group East Asian languages together, group Germanic languages together, etc.) and remove words or tokens from the multilingual vocabulary that are not associated with a language within the relevant locale (e.g., for improved resource consumption/performance). For example, if the contact center system 106 is supporting Eastern Europe, it is unlikely that Japanese, Korean, and Chinese words or tokens would be beneficial to natural language understanding, as the likelihood of use is very low, and therefore those languages may be removed from the multilingual vocabulary. It should be appreciated that the language groupings may be distinct in some embodiments, whereas they language groupings may overlap with one another in other embodiments (e.g., one grouping could include all European languages, another grouping could include Germanic languages, another grouping could include Romantic languages, etc.). Additionally, in some embodiments, the initial multilingual vocabulary is likely to be a generic vocabulary and, therefore, the system 100 may train the artificial intelligence model with respect to contact center and/or domain-specific keywords.

It should be appreciated that each of the cloud-based system 102, network 104, contact center system 106, and/or user device 108 may be embodied as any type of device/system, collection of devices/systems, or portion(s) thereof suitable for performing the functions described herein.

The cloud-based system 102 may be embodied as any one or more types of devices/systems capable of performing the functions described herein. For example, in the illustrative embodiment, the cloud-based system 102 may be configured to train the artificial intelligence model with respect to contact center and domain-specific keywords, reduce the size of the multilingual vocabulary and model, and/or otherwise leverage the technologies described herein. More specifically, in some embodiments, the cloud-based system 102 may perform knowledge distillation through machine learning to teach a student artificial intelligence model to reduce the size of the multilingual vocabulary, remove tokens from the multilingual vocabulary based on the grouping of languages with linguistic similarities to reduce the size of the multilingual vocabulary, and perform natural language understanding of the user text received by the cloud-based system 102. For example, the cloud-based system 102 may parse the user text into one or more tokens, identify token indexes associated with the tokens in the reduced multilingual vocabulary, determine embedding values associated with the identified token indexes, and generate a multilingual embedding output for the user text (e.g., indicative of user intent) based on the embedding values using machine learning. The cloud-based system 102 may include one or more data stores or databases configured to store various models, embeddings, classifiers, and/or other data relevant to the features described herein. Further, the cloud-based system 102 may be configured to perform feature extraction (e.g., using custom embeddings, general embeddings, etc.), confidence classification, ranking, and/or perform other features related to natural language processing.

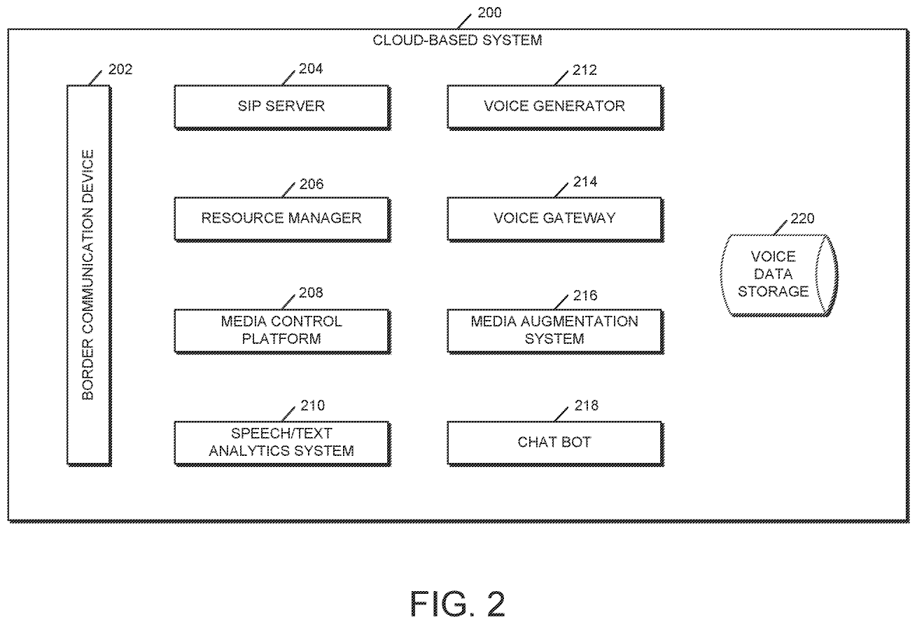

Although the cloud-based system 102 is described herein in the singular, it should be appreciated that the cloud-based system 102 may be embodied as or include multiple servers/systems in some embodiments. Further, although the cloud-based system 102 is described herein as a cloud-based system, it should be appreciated that the system 102 may be embodied as one or more servers/systems residing outside of a cloud computing environment in other embodiments. In some embodiments, the cloud-based system 102 may be embodied as, or similar to, the cloud-based system 200 described in reference to FIG. 2.

In cloud-based embodiments, the cloud-based system 102 may be embodied as a server-ambiguous computing solution, for example, that executes a plurality of instructions on-demand, contains logic to execute instructions only when prompted by a particular activity/trigger, and does not consume computing resources when not in use. That is, system 102 may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system 102 described herein. For example, when an event occurs (e.g., data is transferred to the system 102 for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system 102), the appropriate virtual function(s) may be executed to perform the actions before eliminating the instance of the virtual function(s).

The network 104 may be embodied as any one or more types of communication networks that are capable of facilitating communication between the various devices communicatively connected via the network 104. As such, the network 104 may include one or more networks, routers, switches, access points, hubs, computers, and/or other intervening network devices. For example, the network 104 may be embodied as or otherwise include one or more cellular networks, telephone networks, local or wide area networks, publicly available global networks (e.g., the Internet), ad hoc networks, short-range communication links, or a combination thereof. In some embodiments, the network 104 may include a circuit-switched voice or data network, a packet-switched voice or data network, and/or any other network able to carry voice and/or data. In particular, in some embodiments, the network 104 may include Internet Protocol (IP)-based and/or asynchronous transfer mode (ATM)-based networks. In some embodiments, the network 104 may handle voice traffic (e.g., via a Voice over IP (VOIP) network), web traffic (e.g., such as hypertext transfer protocol (HTTP) traffic and hypertext markup language (HTML) traffic), and/or other network traffic depending on the particular embodiment and/or devices of the system 100 in communication with one another. In various embodiments, the network 104 may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. The network 104 may enable connections between the various devices/systems 102, 106, 108 of the system 100. It should be appreciated that the various devices/systems 102, 106, 108 may communicate with one another via different networks 104 depending on the source and/or destination devices/systems 102, 106, 108.

In some embodiments, it should be appreciated that the cloud-based system 102 may be communicatively coupled to the contact center system 106, form a portion of the contact center system 106, and/or be otherwise used in conjunction with the contact center system 106. For example, the contact center system 106 may include a chat bot (e.g., similar to the chat bot 218 of FIG. 2) configured to communicate with a user (e.g., via the user device 108). Further, in some embodiments, the user device 108 may communicate directly with the cloud-based system 102.

The contact center system 106 may be embodied as any system capable of providing contact center services (e.g., call center services) to an end user (e.g., a contact center client) and otherwise performing the functions described herein. Depending on the particular embodiment, it should be appreciated that the contact center system 106 may be located on the premises/campus of the organization utilizing the contact center system 106 and/or located remotely relative to the organization (e.g., in a cloud-based computing environment). In some embodiments, a portion of the contact center system 106 may be located on the organization's premises/campus while other portions of the contact center system 106 are located remotely relative to the organization's premises/campus. As such, it should be appreciated that the contact center system 106 may be deployed in equipment dedicated to the organization or third-party service provider thereof and/or deployed in a remote computing environment such as, for example, a private or public cloud environment with infrastructure for supporting multiple contact centers for multiple enterprises. In some embodiments, the contact center system 106 includes resources (e.g., personnel, computers, and telecommunication equipment) to enable delivery of services via telephone and/or other communication mechanisms. Such services may include, for example, technical support, help desk support, emergency response, and/or other contact center services depending on the particular type of contact center.

The user device 108 may be embodied as any type of device capable of executing an application and otherwise performing the functions described herein. For example, in some embodiments, the user device 108 is configured to execute an application to participate in a conversation with a personal bot, automated agent, conversational bot, chat bot, or other automated system. As such, the user device 108 may have various input/output devices with which a user may interact to provide and receive audio, text, video, and/or other forms of data. It should be appreciated that the application may be embodied as any type of application suitable for performing the functions described herein. In particular, in some embodiments, the application may be embodied as a mobile application (e.g., a smartphone application), a cloud-based application, a web application, a thin-client application, and/or another type of application. For example, in some embodiments, application may serve as a client-side interface (e.g., via a web browser) for a web-based application or service.

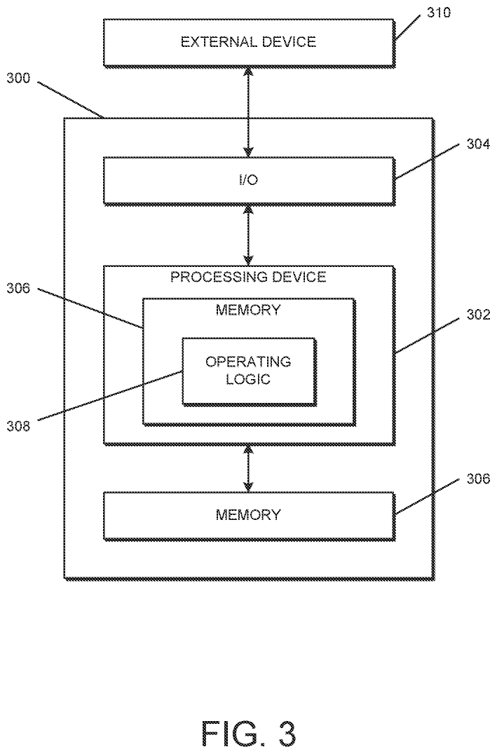

It should be appreciated that each of the cloud-based system 102, the network 104, the contact center system 106, and/or the user device 108 may be embodied as (and/or include) one or more computing devices similar to the computing device 300 described below in reference to FIG. 3. For example, in the illustrative embodiment, each of the cloud-based system 102, the network 104, the contact center system 106, and/or the user device 108 may include a processing device 302 and a memory 306 having stored thereon operating logic 308 (e.g., a plurality of instructions) for execution by the processing device 302 for operation of the corresponding device.

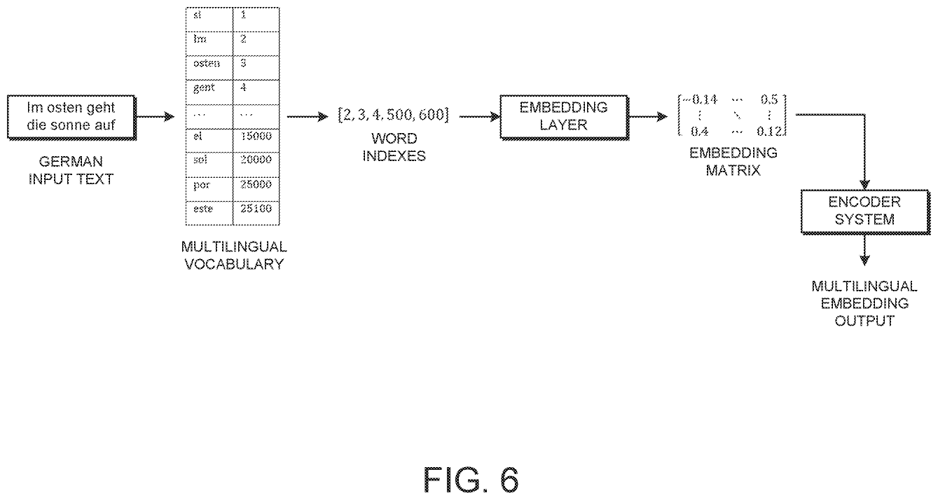

An example architecture of a multilingual encoder model is depicted in FIG. 6, which leverages a multilingual vocabulary and multilingual embeddings to capture the meaning of words in multiple languages. As shown, the example input text is the German text, “Im osten geht die sonne auf.” The input text is divided into individual tokens (e.g., “Im”, “osten”, “geht”, “die”, “sonne”, “auf”), and the corresponding token indexes are looked up in the multilingual vocabulary. The token indexes are then passed to the embedding layer, which generates multilingual embedding values (e.g., in the form of floating point values) that serve as inputs to the encoder system to produce a contextual embeddings output. Although the individual tokens in this embodiment are words, it should be appreciated that the tokens may be other units of text, for example, represented in the form of a word, sub-word units, individual characters, combinations of words, etc. It should be appreciated that the multilingual vocabulary includes a set of tokens that are shared across different languages which occur frequently within those languages. For example, the illustrative embodiment depicts a multilingual vocabulary that includes at least German tokens. It should be appreciated that each token in the multilingual vocabulary may be assigned a token index (e.g., a unique numerical identifier). For example, as shown in FIG. 6, the word/token “si” has been assigned the token index “1”, the word/token “Im” has been assigned the token index “2”, and so forth. The embedding layer may transform the token indexes associated with the input text into embeddings (e.g., dense vector representation), which may capture semantic and contextual information of words in a continuous vector space. For example, the embedding layer may be embodied as a matrix where each row corresponds with a token index in the vocabulary, and the token index itself being associated with an n-dimensional vector. The encoder system may include one or more layers of a neural network or other machine learning technology, and transform the sequence of input embedding vectors into a fixed length vector representation that captures the overall information of the sequence. It should be appreciated that the contextual vector generated by the encoder system may be independent of any specific language, as the multilingual embedding output may capture semantic and contextual information across different languages.

Referring now to FIG. 2, a simplified block diagram of at least one embodiment cloud-based system 200 is shown. The illustrative cloud-based system 200 includes a border communication device 202, a SIP server 204, a resource manager 206, a media control platform 208, a speech/text analytics system 210, a voice generator 212, a voice gateway 214, a media augmentation system 216, a chat bot 218, and voice data storage 220. Although only one border communication device 202, one SIP server 204, one resource manager 206, one media control platform 208, one speech/text analytics system 210, one voice generator 212, one voice gateway 214, one media augmentation system 216, one chat bot 218, and one voice data storage 220 are shown in the illustrative embodiment of FIG. 2, the cloud-based system 200 may include multiple border communication devices 202, SIP servers 204, resource managers 206, media control platforms 208, speech/text analytics systems 210, voice generators 212, voice gateways 214, media augmentation systems 216, chat bots 218, and/or voice data storages 220 in other embodiments. For example, in some embodiments, multiple chat bots 218 may be used to communicate regarding different subject matters handled by the same cloud-based system 200. Further, in some embodiments, one or more of the components described herein may be excluded from the system 200, one or more of the components described as being independent may form a portion of another component, and/or one or more of the component described as forming a portion of another component may be independent.

The border communication device 202 may be embodied as any one or more types of devices/systems that are capable of performing the functions described herein. For example, in some embodiments, the border communication device 202 may be configured to control signaling and media streams involved in setting up, conducting, and tearing down voice conversations and other media communications between, for example, an end user and contact center system. In some embodiments, the border communication device 202 may be a session border controller (SBC) controlling the signaling and media exchanged during a media session (also referred to as a “call,” “telephony call,” or “communication session”) between the end user and contact center system. In some embodiments, the signaling exchanged during a media session may include SIP, H.323, Media Gateway Control Protocol (MGCP), and/or any other voice-over IP (VOIP) call signaling protocols. The media exchanged during a media session may include media streams that carry the call's audio, video, or other data along with information of call statistics and quality.

In some embodiments, the border communication device 202 may operate according to a standard SIP back-to-back user agent (B2BUA) configuration. In this regard, the border communication device 202 may be inserted in the signaling and media paths established between a calling and called parties in a VoIP call. In some embodiments, it should be understood that other intermediary software and/or hardware devices may be invoked in establishing the signaling and/or media paths between the calling and called parties.

In some embodiments, the border communication device 202 may exert control over the signaling (e.g., SIP messages) and media streams (e.g., RTP data) routed to and from an end user device (e.g., the user device 108) and a contact center system (e.g., the contact center system 106) that traverse the network (e.g., the network 104). In this regard, the border communication device 202 may be coupled to trunks that carry signals and media for calls to and from the user device over the network, and to trunks that carry signals and media to and from the contact center system over the network.

The SIP server 204 may be embodied as any one or more types of devices/systems that are capable of performing the functions described herein. For example, in some embodiments, the SIP server 204 may act as a SIP B2UBA and may control the flow of SIP requests and responses between SIP endpoints. Any other controller configured to set up and tear down VOIP communication sessions may be contemplated in addition to or in lieu of the SIP server 204 in other embodiments. The SIP server 204 may be a separate logical component or may be combined with the resource manager 206. In some embodiments, the SIP server 204 may be hosted at a contact center system (e.g., the contact center system 106). Although a SIP server 204 is used in the illustrative embodiment, another call server configured with another VoIP protocol may be used in addition to or in lieu of SIP, such as, for example, H.232 protocol, Media Gateway Control Protocol, Skype protocol, and/or other suitable technologies in other embodiments.

The resource manager 206 may be embodied as any one or more types of devices/systems that are capable of performing the functions described herein. In the illustrative embodiment, the resource manager 206 may be configured to allocate and monitor a pool of media control platforms for providing load balancing and high availability for each resource type. In some embodiments, the resource manager 206 may monitor and may select a media control platform 208 from a cluster of available platforms. The selection of the media control platform 208 may be dynamic, for example, based on identification of a location of a calling end user, type of media services to be rendered, detected quality of a current media service, and/or other factors.

In some embodiments, the resource manager 206 may be configured to process requests for media services, and interact with, for example, a configuration server having a configuration database, to determine an interactive voice response (IVR) profile, voice application (e.g. Voice Extensible Markup Language (Voice XML) application), announcement, and conference application, resource, and service profile that can deliver the service, such as, for example, a media control platform. According to some embodiments, the resource manager may provide hierarchical multi-tenant configurations for service providers, enabling them to apportion a select number of resources for each tenant.

In some embodiments, the resource manager 206 may be configured to act as a SIP proxy, a SIP registrar, and/or a SIP notifier. In this regard, the resource manager 206 may act as a proxy for SIP traffic between two SIP components. As a SIP registrar, the resource manager 206 may accept registration of various resources via, for example, SIP REGISTER messages. In this manner, the cloud-based system 200 may support transparent relocation of call-processing components. In some embodiments, components such as the media control platform 208 do not register with the resource manager 206 at startup. The resource manager 206 may detect instances of the media control platform 208 through configuration information retrieved from the configuration database. If the media control platform 208 has been configured for monitoring, the resource manager 206 may monitor resource health by using, for example, SIP OPTIONS messages. In some embodiments, to determine whether the resources in the group are alive, the resource manager 206 may periodically send SIP OPTIONS messages to each media control platform 208 resource in the group. If the resource manager 206 receives an OK response, the resources are considered alive. It should be appreciated that the resource manager 206 may be configured to perform other various functions, which have been omitted for brevity of the description. The resource manager 206 and the media control platform 208 may collectively be referred to as a media controller.

In some embodiments, the resource manager 206 may act as a SIP notifier by accepting, for example, SIP SUBSCRIBE requests from the SIP server 204 and maintaining multiple independent subscriptions for the same or different SIP devices. The subscription notices are targeted for the tenants that are managed by the resource manager 206. In this role, the resource manager 206 may periodically generate SIP NOTIFY requests to subscribers (or tenants) about port usage and the number of available ports. The resource manager 206 may support multi-tenancy by sending notifications that contain the tenant name and the current status (in- or out-of-service) of the media control platform 208 that is associated with the tenant, as well as current capacity for the tenant.

The media control platform 208 may be embodied as any service or system capable of providing media services and otherwise performing the functions described herein. For example, in some embodiments, the media control platform 208 may be configured to provide call and media services upon request from a service user. Such services may include, without limitation, initiating outbound calls, playing music or providing other media while a call is placed on hold, call recording, conferencing, call progress detection, playing audio/video prompts during a customer self-service session, and/or other call and media services. One or more of the services may be defined by voice applications (e.g. VoiceXML applications) that are executed as part of the process of establishing a media session between the media control platform 208 and the end user.

The speech/text analytics system (STAS) 210 may be embodied as any service or system capable of providing various speech analytics and text processing functionalities (e.g., text-to-speech) as will be understood by a person of skill in the art and otherwise performing the functions described herein. The speech/text analytics system 210 may perform automatic speech and/or text recognition and grammar matching for end user communications sessions that are handled by the cloud-based system 200. The speech/text analytics system 210 may include one or more processors and instructions stored in machine-readable media that are executed by the processors to perform various operations. In some embodiments, the machine-readable media may include non-transitory storage media, such as hard disks and hardware memory systems.

The voice generator 212 may be embodied as any service or system capable of generating a voice communication and otherwise performing the functions described herein. In some embodiments, the voice generator 212 may generate the voice communication based on a particular voice signature.

The voice gateway 214 may be embodied as any service or system capable of performing the functions described herein. In the illustrative embodiment, the voice gateway 214 receives end user calls from or places calls to voice communications devices, such as an end user device, and responds to the calls in accordance with a voice program that corresponds to a communication routing configuration of the contact center system. In some embodiments, the voice program may include a voice avatar. The voice program may be accessed from local memory within the voice gateway 214 or from other storage media in the cloud-based system 200. In some embodiments, the voice gateway 214 may process voice programs that are script-based voice applications. The voice program, therefore, may be a script written in a scripting language, such as voice extensible markup language (VoiceXML) or speech application language tags (SALT). The cloud-based system 200 may also communicate with the voice data storage 220 to read and/or write user interaction data (e.g., state variables for a data communications session) in a shared memory space.

The media augmentation system 216 may be embodied as any service or system capable of specifying how the portions of the cloud-based system 200 (e.g., one or more of the border communications device 202, the SIP server 204, the resource manager 206, the media control platform 208, the speech/text analytics system 210, the voice generator 212, the voice gateway 214, the media augmentation system 216, the chat bot 218, the voice data storage 220, and/or one or more portions thereof) interact with each other and otherwise performing the functions described herein. In some embodiments, the media augmentation system 216 may be embodied as or include an application program interface (API). In some embodiments, the media augmentation system 216 enables integration of differing parameters and/or protocols that are used with various planned application and media types utilized within the cloud-based system 200.

The chat bot 218 may be embodied as any automated service or system capable of using automation to engage with end users and otherwise performing the functions described herein. For example, in some embodiments, the chat bot 218 may operate, for example, as an executable program that can be launched according to demand for the particular chat bot. In some embodiments, the chat bot 218 simulates and processes human conversation (either written or spoken), allowing humans to interact with digital devices as if the humans were communicating with another human. In some embodiments, the chat bot 218 may be as simple as rudimentary programs that answer a simple query with a single-line response, or as sophisticated as digital assistants that learn and evolve to deliver increasing levels of personalization as they gather and process information. In some embodiments, the chat bot 218 includes and/or leverages artificial intelligence, adaptive learning, bots, cognitive computing, and/or other automation technologies. Chat bot 218 may also be referred to herein as one or more conversational bots, chat robots, AI chat bots, automated chat robot, chatterbots, dialog systems, conversational agents, automated chat resources, and/or bots.

A benefit of utilizing automated chat robots for engaging in chat conversations with end users may be that it helps contact centers to more efficiently use valuable and costly resources like human resources, while maintaining end user satisfaction. For example, chat robots may be invoked to initially handle chat conversations without a human end user knowing that it is conversing with a robot. The chat conversation may be escalated to a human resource if and when appropriate. Thus, human resources need not be unnecessarily tied up in handling simple requests and may instead be more effectively used to handle more complex requests or to monitor the progress of many different automated communications at the same time.

As described herein, in illustrative embodiments, the chat bot 218 may be embodied as a knowledge-only bot that relies on knowledge bases created, for example, using organization FAQs, product documents, user manuals, and/or other relevant documentation.

The voice data storage 220 may be embodied as one or more databases, data structures, and/or data storage devices capable of storing data in the cloud-based system 200 or otherwise facilitating the storage of such data for the cloud-based system 200. For example, in some embodiments, the voice data storage 220 may include one or more cloud storage buckets. In other embodiments, it should be appreciated that the voice data storage 220 may, additionally or alternatively, include other types of voice data storage mechanisms that allow for dynamic scaling of the amount of data storage available to the cloud-based system 200. In some embodiments, the voice data storage 220 may store scripts (e.g., pre-programmed scripts or otherwise). Although the voice data storage 220 is described herein as data storages and databases, it should be appreciated that the voice data storage 220 may include both a database (or other type of organized collection of data and structures) and data storage for the actual storage of the underlying data. The voice data storage 220 may store various data useful for performing the functions described herein.

Referring now to FIG. 3, a simplified block diagram of at least one embodiment of a computing device 300 is shown. The illustrative computing device 300 depicts at least one embodiment of a cloud-based system, contact center system, and/or user device that may be utilized in connection with the cloud-based system 102, the contact center system 106, and/or the user device 108 (and/or a portion thereof) illustrated in FIG. 1. Further, in some embodiments, one or more of the border communications device 202, the SIP server 204, the resource manager 206, the media control platform 208, the speech/text analytics system 210, the voice generator 212, the voice gateway 214, the media augmentation system 216, the chat bot 218, and/or the voice data storage 220 (and/or a portion thereof) may be embodied as or executed by a computing device similar to the computing device 300. Depending on the particular embodiment, the computing device 300 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 300 includes a processing device 302 that executes algorithms and/or processes data in accordance with operating logic 308, an input/output device 304 that enables communication between the computing device 300 and one or more external devices 310, and memory 306 which stores, for example, data received from the external device 310 via the input/output device 304.

The input/output device 304 allows the computing device 300 to communicate with the external device 310. For example, the input/output device 304 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 300 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 300. The input/output device 304 may include hardware, software, and/or firmware suitable for performing the techniques described herein.

The external device 310 may be any type of device that allows data to be inputted or outputted from the computing device 300. For example, in various embodiments, the external device 310 may be embodied as the cloud-based system 102, the contact center system 106, the user device 108, and/or a portion thereof. Further, in some embodiments, the external device 310 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 310 may be integrated into the computing device 300.

The processing device 302 may be embodied as any type of processor(s) capable of performing the functions described herein. In particular, the processing device 302 may be embodied as one or more single or multi-core processors, microcontrollers, or other processor or processing/controlling circuits. For example, in some embodiments, the processing device 302 may include or be embodied as an arithmetic logic unit (ALU), central processing unit (CPU), digital signal processor (DSP), and/or another suitable processor(s). The processing device 302 may be a programmable type, a dedicated hardwired state machine, or a combination thereof. Processing devices 302 with multiple processing units may utilize distributed, pipelined, and/or parallel processing in various embodiments. Further, the processing device 302 may be dedicated to performance of just the operations described herein, or may be utilized in one or more additional applications. In the illustrative embodiment, the processing device 302 is programmable and executes algorithms and/or processes data in accordance with operating logic 308 as defined by programming instructions (such as software or firmware) stored in memory 306. Additionally or alternatively, the operating logic 308 for processing device 302 may be at least partially defined by hardwired logic or other hardware. Further, the processing device 302 may include one or more components of any type suitable to process the signals received from input/output device 304 or from other components or devices and to provide desired output signals. Such components may include digital circuitry, analog circuitry, or a combination thereof.

The memory 306 may be of one or more types of non-transitory computer-readable media, such as a solid-state memory, electromagnetic memory, optical memory, or a combination thereof. Furthermore, the memory 306 may be volatile and/or nonvolatile and, in some embodiments, some or all of the memory 306 may be of a portable type, such as a disk, tape, memory stick, cartridge, and/or other suitable portable memory. In operation, the memory 306 may store various data and software used during operation of the computing device 300 such as operating systems, applications, programs, libraries, and drivers. It should be appreciated that the memory 306 may store data that is manipulated by the operating logic 308 of processing device 302, such as, for example, data representative of signals received from and/or sent to the input/output device 304 in addition to or in lieu of storing programming instructions defining operating logic 308. As shown in FIG. 3, the memory 306 may be included with the processing device 302 and/or coupled to the processing device 302 depending on the particular embodiment. For example, in some embodiments, the processing device 302, the memory 306, and/or other components of the computing device 300 may form a portion of a system-on-a-chip (SoC) and be incorporated on a single integrated circuit chip.

In some embodiments, various components of the computing device 300 (e.g., the processing device 302 and the memory 306) may be communicatively coupled via an input/output subsystem, which may be embodied as circuitry and/or components to facilitate input/output operations with the processing device 302, the memory 306, and other components of the computing device 300. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 300 may include other or additional components, such as those commonly found in a typical computing device (e.g., various input/output devices and/or other components), in other embodiments. It should be further appreciated that one or more of the components of the computing device 300 described herein may be distributed across multiple computing devices. In other words, the techniques described herein may be employed by a computing system that includes one or more computing devices. Additionally, although only a single processing device 302, I/O device 304, and memory 306 are illustratively shown in FIG. 3, it should be appreciated that a particular computing device 300 may include multiple processing devices 302, I/O devices 304, and/or memories 306 in other embodiments. Further, in some embodiments, more than one external device 310 may be in communication with the computing device 300.

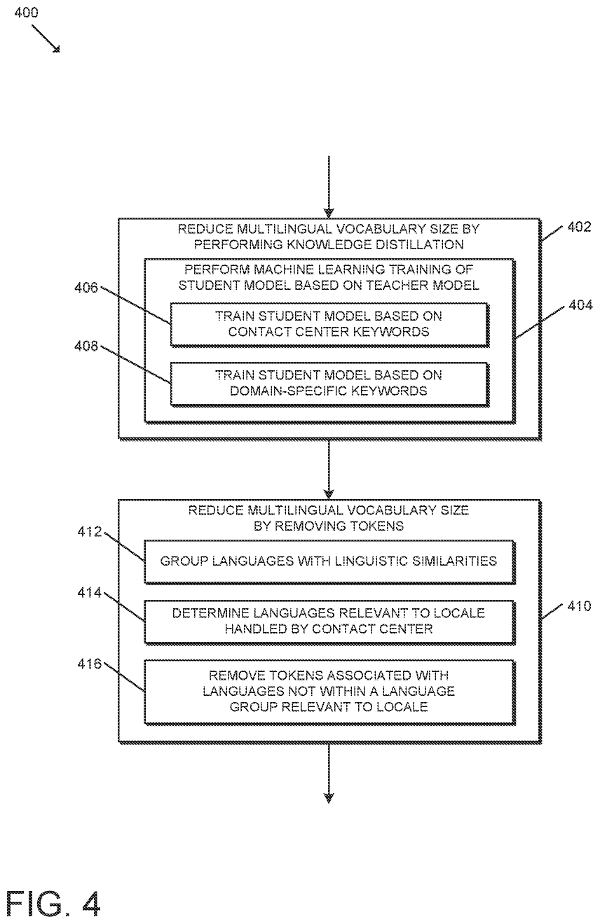

Referring now to FIG. 4, in use, a computing system (e.g., the system 100, the cloud-based system 102, the contact center system 106, and/or other computing devices described herein) may execute a method 400 for reducing the size of and augmenting a multilingual vocabulary. It should be appreciated that the particular blocks of the method 400 are illustrated by way of example, and such blocks may be combined or divided, added or removed, and/or reordered in whole or in part depending on the particular embodiment, unless stated to the contrary.

The illustrative method 400 begins with block 402 in which the computing system reduces the size of a multilingual vocabulary (e.g., an initial multilingual vocabulary) by performing knowledge distillation through machine learning to teach a student artificial intelligence model based on a teacher artificial intelligence model. In doing so, in block 404, the computing system performs machine learning (e.g., using an artificial neural network) to train the student artificial intelligence model to the teacher artificial intelligence models' representation for various keywords. More specifically, in block 406, the computing system trains the student artificial intelligence model based on contact center keywords and, in block 408, the computing system trains the student artificial intelligence model based on domain-specific keywords. In other words, in the illustrative embodiment, the student artificial intelligence model learns the teacher artificial intelligence model's representation for the contact center and domain-specific keywords.

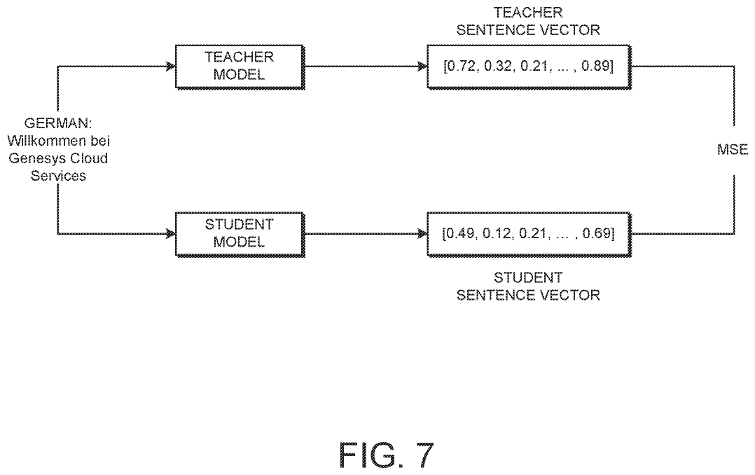

An example architecture for training/teaching a student artificial intelligence model based on a teacher artificial intelligence model and reducing the size of an initial multilingual vocabulary is shown in FIG. 7. It should be appreciated that the computing system may perform knowledge distillation through machine learning, which may involve leveraging a larger model (e.g., the teacher model) to transfer the knowledge from the teacher model to the student model, which may include fewer machine learning embedding layers than the teacher model. The student model may be trained to minimize the difference between the teacher sentence vector and the student sentence vector based on mean squared error (MSE) loss in an effort to have the student model output match the output of the teacher model while reducing the size of the model and reducing resource consumption. It should be further appreciated that the teacher and student models may be trained using additional keywords/tokens, such as contact center and domain-specific keywords. Multilingual vocabularies may be generic and trained on input data in the form of phrases or sentences that cover a wide range of patterns and semantics. Although providing breadth, this approach may be limiting with respect to having a proper understanding of language used in a contact center interaction and/or a particular domain (e.g., the banking industry). For example, human users tend to use different vernacular when communicating with a conversational bot than human agents, often relying on very direct statements (e.g., yes, no, I understand, help, start over, cancel, start, etc.). Similarly, domain-specific language may involve different use of traditional language (e.g., the banking industry, medical industry, etc.). For example, the word “heart” may refer to an organ of the human body or a shape depending on the particular domain. Accordingly, the computing system may train the teacher model and the student model to incorporate contact center and/or domain-specific tokens in some embodiments. It should be further appreciated that, in some embodiments, the multilingual vocabulary may be further reduced by eliminating duplicate keyword entries. For example, in an embodiment, the tokens “start over” and “restart” may be consolidated into a single token for better improve performance.

Referring back to FIG. 4, in block 410, the computing system reduces the size of the multilingual vocabulary by removing tokens from the multilingual library (e.g., the initial multilingual library, such as before or after performing knowledge distillation and/or augmentation). In particular, in block 412, the computing system may group languages with linguistic similarities as described above and, in block 414, the computing system may determine which languages are relevant to the locale (or locales) handled by the contact center system 106. In block 416, the computing system removes tokens from the multilingual vocabulary associated with languages not within a group of languages relevant to the locale handled by the contact center system 106. For example, as described above, the computing system may group Eastern European languages together and group East Asian languages together based on linguistic similarity (e.g., due to lack of frequent overlap in the underlying vocabulary). Therefore, if the locale being handled by the contact center system 106 is within East Asia, the computing system may remove tokens from the multilingual vocabulary from the Eastern European language grouping (e.g., German language tokens, French language tokens, Spanish language tokens, etc.) and/or otherwise not relevant to the East Asian language grouping. It should be appreciated that utilizing different multilingual vocabularies based on language groupings and locales allows for the reduction in the size of the multilingual vocabulary while ensuring that the pruning of one vocabulary does not affect performance in another locale.

Although the blocks 402-416 are described in a relatively serial manner, it should be appreciated that various blocks of the method 400 may be performed in parallel in some embodiments. It should be appreciated that the method 400 improves the system performance, for example, by reducing the memory consumption (or other resource consumption) of the multilingual vocabulary and/or artificial intelligence model (e.g., the student model) used for natural language processing.

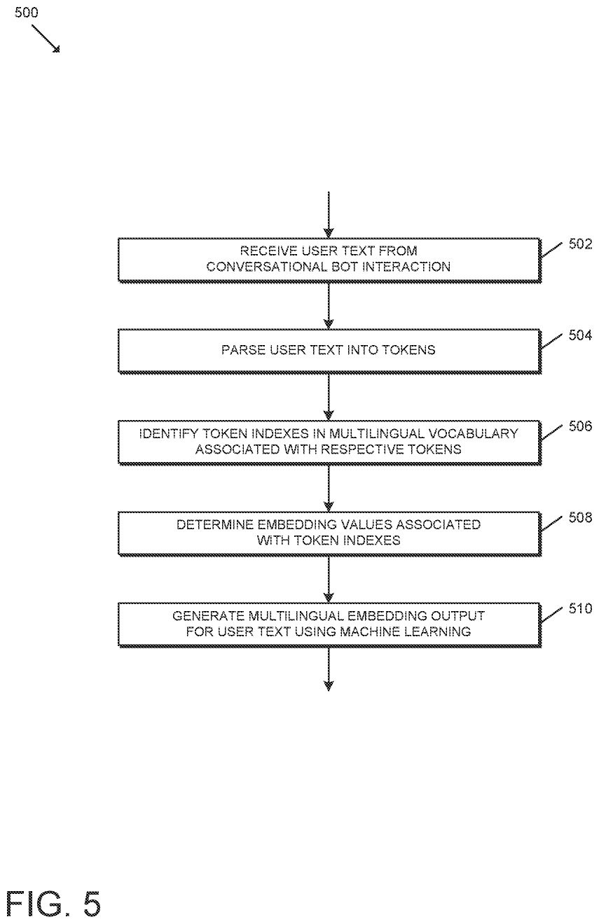

Referring now to FIG. 5, in use, a computing system (e.g., the system 100, the cloud-based system 102, the contact center system 106, and/or other computing devices described herein) may execute a method 500 for leveraging improved conversational bots in a contact center system. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system receives user text of a human user from an interaction with a conversational bot. For example, the user text may be a human user's query or command to the conversational bot. Although described as being text, it should be appreciated that, in some embodiments, the human user may communicate with an automated agent verbally, which in turn may be converted into the user text via automated speech recognition and speech-to-text technologies. In block 504, the computing system parses the user text into tokens using natural language processing.

In block 506, the computing system identifies the token indexes in the multilingual vocabulary (e.g., the reduced multilingual vocabulary described above) associated with the respective tokens from the tokenized user text. In block 508, the computing system determines the embedding values associated with those token indexes, and in block 510, the computing system generates a multilingual embedding output for the user text based on the embedding values using machine learning (e.g., using a neural network). It should be appreciated that the multilingual embedding output is indicative of the user intent based on the user text. In some embodiments, the multilingual embedding output may be embodied as a fixed length vector representation of the user text.

Although the blocks 502-510 are described in a relatively serial manner, it should be appreciated that various blocks of the method 500 may be performed in parallel in some embodiments.

What is claimed is:

1. A method of leveraging improved conversational bots in a contact center system, the method comprising:
performing, by a computing system, knowledge distillation through machine learning to teach a student artificial intelligence model based on a teacher artificial intelligence model and reduce a size of an initial multilingual vocabulary, wherein the student artificial intelligence model includes fewer machine learning embedding layers than the teacher artificial intelligence model;
removing, by the computing system, tokens from the initial multilingual vocabulary based on a grouping of languages with linguistic similarities to reduce the size of the initial multilingual vocabulary;
parsing, by the computing system, user text from a human user into one or more tokens using natural language processing;
identifying, by the computing system, token indexes associated with the respective one or more tokens in a reduced multilingual vocabulary, wherein the reduced multilingual vocabulary is generated from performing the knowledge distillation and removing the tokens from the initial multilingual vocabulary;
determining, by the computing system, embedding values associated with the identified token indexes; and
generating, by the computing system, a multilingual embedding output for the user text based on the embedding values using machine learning, wherein the multilingual embedding output is indicative of an intent of the user text.

2. The method of claim 1, wherein performing knowledge distillation through machine learning to teach the student artificial intelligence model based on the teacher artificial intelligence model and reduce the size of the initial multilingual vocabulary comprises reducing a memory consumption of the initial multilingual vocabulary.

3. The method of claim 1, wherein removing the tokens from the initial multilingual vocabulary based on the grouping of languages with linguistic similarities to reduce the size of the initial multilingual vocabulary comprises reducing a memory consumption of the initial multilingual vocabulary.

4. The method of claim 1, wherein performing the knowledge distillation through machine learning to teach the student artificial intelligence model based on the teacher artificial intelligence model comprises performing machine learning to train the student artificial intelligence model with respect to the teacher artificial intelligence model's representation of contact center keywords.

5. The method of claim 1, wherein performing the knowledge distillation through machine learning to teach the student artificial intelligence model based on the teacher artificial intelligence model comprises performing machine learning to train the student artificial intelligence model with respect to the teacher artificial intelligence model's representation of domain-specific keywords.

6. The method of claim 1, wherein removing tokens from the initial multilingual vocabulary based on the grouping of languages with linguistic similarities comprises:
determining one or more languages relevant to a locale handled by the contact center system; and
removing tokens from the initial multilingual vocabulary associated with languages not within a group of languages relevant to the locale handled by the contact center system.

7. The method of claim 1, wherein generating the multilingual embedding output for the user text based on the embedding values comprises generating a fixed length vector representation of the user text based on the embedding values.

8. The method of claim 1, wherein generating the multilingual embedding output for the user text based on the embedding values using machine learning comprises generating the multilingual embedding output for the user text based on the embedding values using a neural network.

9. The method of claim 1, further comprising receiving, by the computing system, the user text from an interaction between the human user and a conversational bot of the contact center system.

10. The method of claim 1, wherein each token of the initial multilingual vocabulary is represented by a multi-dimensional vector of floating point values.

11. A computing system for leveraging improved conversational bots in a contact center system, the computing system comprising:
at least one processor; and
at least one memory comprising a plurality of instructions stored thereon that, in response to execution by the at least one processor, causes the computing system to:
perform knowledge distillation through machine learning to teach a student artificial intelligence model based on a teacher artificial intelligence model and reduce a size of an initial multilingual vocabulary, wherein the student artificial intelligence model includes fewer machine learning embedding layers than the teacher artificial intelligence model;
remove tokens from the initial multilingual vocabulary based on a grouping of languages with linguistic similarities to reduce the size of the initial multilingual vocabulary;
parse user text from a human user into one or more tokens using natural language processing;
identify token indexes associated with the respective one or more tokens in a reduced multilingual vocabulary, wherein the reduced multilingual vocabulary is generated from performing the knowledge distillation and removing the tokens from the initial multilingual vocabulary;
determine embedding values associated with the identified token indexes; and
generate a multilingual embedding output for the user text based on the embedding values using machine learning, wherein the multilingual embedding output is indicative of an intent of the user text.

12. The computing system of claim 11, wherein to perform knowledge distillation through machine learning to teach the student artificial intelligence model based on the teacher artificial intelligence model and reduce the size of the initial multilingual vocabulary comprises to reduce a memory consumption of the initial multilingual vocabulary.

13. The computing system of claim 11, wherein to remove the tokens from the initial multilingual vocabulary based on the grouping of languages with linguistic similarities to reduce the size of the initial multilingual vocabulary comprises to reduce a memory consumption of the initial multilingual vocabulary.

14. The computing system of claim 11, wherein to perform the knowledge distillation through machine learning to teach the student artificial intelligence model based on the teacher artificial intelligence model comprises to perform machine learning to train the student artificial intelligence model with respect to the teacher artificial intelligence model's representation of contact center keywords.

15. The computing system of claim 11, wherein to perform the knowledge distillation through machine learning to teach the student artificial intelligence model based on the teacher artificial intelligence model comprises to perform machine learning to train the student artificial intelligence model with respect to the teacher artificial intelligence model's representation of domain-specific keywords.

16. The computing system of claim 11, wherein to remove tokens from the initial multilingual vocabulary based on the grouping of languages with linguistic similarities comprises to:
determine one or more languages relevant to a locale handled by the contact center system; and
remove tokens from the initial multilingual vocabulary associated with languages not within a group of languages relevant to the locale handled by the contact center system.

17. The computing system of claim 11, wherein to generate the multilingual embedding output for the user text based on the embedding values comprises to generate a fixed length vector representation of the user text based on the embedding values.

18. The computing system of claim 11, wherein to generate the multilingual embedding output for the user text based on the embedding values using machine learning comprises to generate the multilingual embedding output for the user text based on the embedding values using a neural network.

19. The computing system of claim 11, wherein the plurality of instructions further causes the computing system to receive the user text from an interaction between the human user and a conversational bot of the contact center system.

20. The computing system of claim 11, wherein each token of the initial multilingual vocabulary is represented by a multi-dimensional vector of floating point values.
